(19) United States
(12) Patent Application Publication
(10) Pub. No.: US 2005/0254728 A1
(43) Pub. Date: Nov. 17, 2005

(54) Automatic cutting method for digital images

(76) Inventor: Zhuo-Ya Wang, Taipei (TW)

Correspondence Address: HARNESS, DICKEY & PIERCE, P.L.C., P.O. BOX 8910, RESTON, VA, 20195, US

(21) Appl. No.: 10/844,503

(22) Filed: May 13, 2004

(51) Int. Cl. G06K 9/34; G06K 9/48

(52) U.S. Cl. 382/291; 382/199

(57) ABSTRACT

An automatic cutting method for digital images first extracts the brightness of a pixel in an image. The brightness is used to determine a quasi-image pixel. Actual image pixels are then extracted from the quasi-image pixels. The image boundary is then determined according to the image pixels. Finally, the image is cut according to the boundary.

### BACKGROUND OF THE INVENTION

1. Field of Invention

The invention relates to a digital image processing method and, in particular, to an automatic cutting method for digital images.

2. Related Art

Image data are an important type of information. With the development in information sciences that have computers and computation techniques as the kernel, image processing plays an increasingly important role in various fields.

Digitization enables photographers to have more freedom in creation. Images can be processed according to needs. Digital images often need to be processed in order to have satisfactory effects.

Cutting is a commonly used means to process digital images. If the edges of an image are unsatisfactory, one only needs to cut the unnecessary parts off, trimming the edges of the source document and leaving only relevant contents. For example, when placing a picture in the middle of the scanner, one can remove the extra blank portion of the scanned image by cutting, retaining only the picture part. Cutting generally changes the structure of a picture, focusing people's attention to the important part of the image.

The conventional automatic cutting methods usually remove the boundary of the same color. They start from the edges of the original image and approach the center of the image in all four directions, until the boundary is found according to the color criterion. However, if the image has some speckles, it is very hard to accurately determine the boundary of the image using the normal method.

### SUMMARY OF THE INVENTION

In view of the foregoing, the invention provides an automatic cutting method for digital images. A primary objective of the invention is to implement precise cutting of digital images, thereby more accurately emphasizing the important portion of an image.

The disclosed automatic cutting method for digital images performs automatic cutting on an image according to its boundary. It first extracts the brightness of a pixel in an image. The brightness is used to determine a quasi-image pixel. Actual image pixels are then extracted from the quasi-image pixels. The image boundary is then determined according to the image pixels. Finally, the image is cut according to the boundary.

The disclosed automatic cutting method for digital images automatically removes the interference of speckles. Thus, it has a more precise positioning. It only marks the boundary during the process, without replacing the speckled pixels. The processing speed is therefore faster.

### BRIEF DESCRIPTION OF THE DRAWINGS

The invention will become more fully understood from the detailed description given hereinbelow illustration only, and thus are not limitative of the present invention, and wherein:

FIG. 1 is an overall flowchart of the disclosed automatic cutting method for digital images;

FIG. 2 is a flowchart of the first embodiment;

FIG. 3 is a flowchart of determining speckle pixels according to the invention;

FIG. 4 is a flowchart of determining speckle pixels according to the invention;

FIG. 5 is a flowchart of determining the image boundary according to the second embodiment;

FIG. 6 is a flowchart of determining the image boundary according to the third embodiment; and

FIG. 7 is a flowchart of determining the image boundary according to the fourth embodiment.

### DETAILED DESCRIPTION OF THE INVENTION

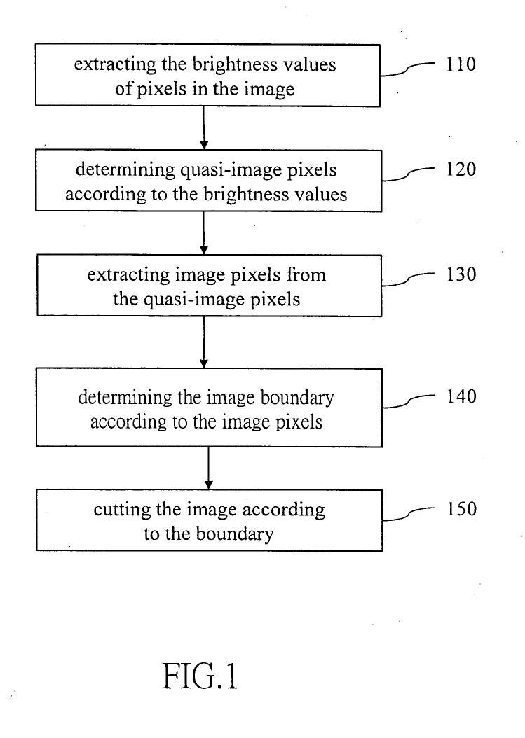

This specification discloses an automatic cutting method for digital images. The overall flowchart of the disclosed method is shown in FIG. 1.

The method first extracts the brightness of a pixel in an image (step 110). The brightness is used to determine a quasi-image pixel (step 120). Actual image pixels are exrtracted from the quasi-image pixels (step 130). An image boundary is determined according to the image pixels (step 140). Cutting is then performed according to the boundary (step 150).

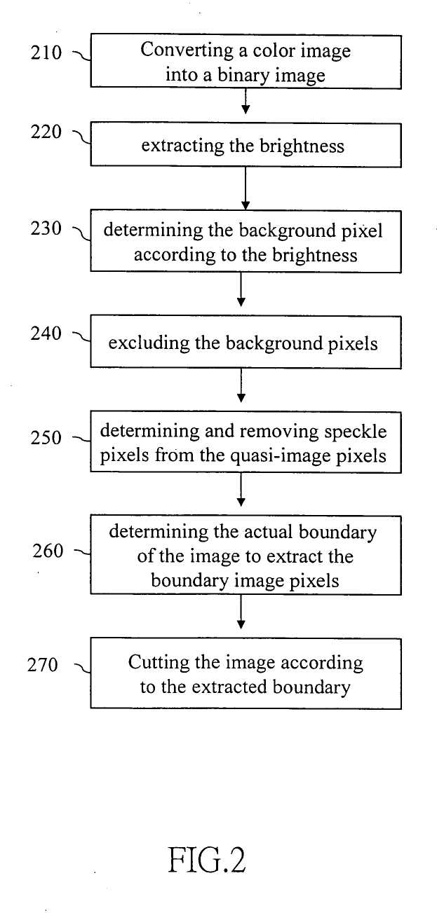

FIG. 2 shows the flowchart of the first embodiment of the invention. First, an image is read into the system. If the image is a color image, it is converted into a binary image (step 210). The image is then converted into the YcbCr format. Each pixel in the image is processed, extracting the brightness, Y (step 220). The Y value is compared with a first base value. The first base value is also called bi-level threshold, and it can be got by taking the average value of two wave crest of an image's grayscale histogram. In the current embodiment, the first base value is 150. If Y is greater than 150, it is considered as a background pixel (step 230). The pixels in the image include background pixels and quasi-image pixels. The quasi-image pixels further include speckle pixels and actual image pixels. After excluding the background pixels (step 240), the image is left with quasi-image pixels. Speckle pixels are further determined and removed from the quasi-image pixels (step 250). Finally, we are left with the image pixels. From the image pixels, we can determine the actual boundary of the image to extract the boundary image pixels (step 260). Therefore, we can determine the enveloping rectangle of the actual image, the enveloping rectangle is the actual boundary of the image. Finally, the image is cut according to the extracted boundary (step 270).

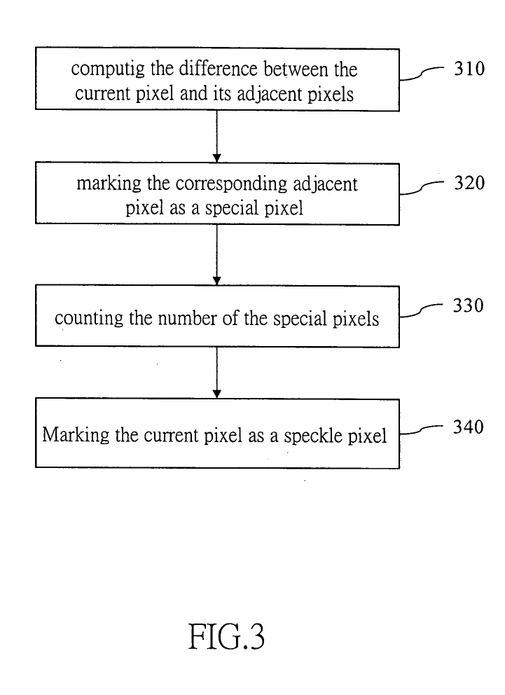

The above-mentioned process of determining speckle pixels is shown in FIG. 3. When determining whether a pixel is a speckle pixel, the method first compute the difference between the current pixel and its adjacent pixels (step 310). The method takes the brightness differences of the current pixel with its eight immediately adjacent pixels and compares each difference with a second base value. If the difference is greater than the second base value, the corresponding adjacent pixel is marked as a special pixel (step 320). The possible range of the second base value is greater than 7. The current embodiment uses 10 as the second base value. The number of the special pixels is counted (step 330). If the number is greater than a third base value, the current pixel is marked as a speckle pixel (step 340). In the current embodiment, the third base value is 4.

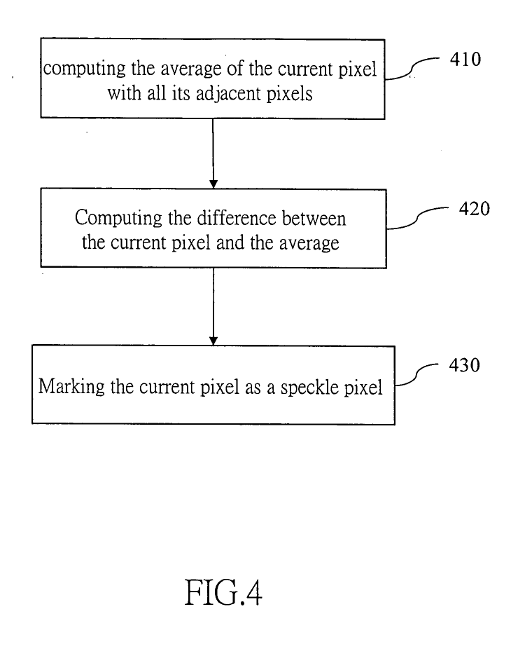

One may also use the mean value method to determine speckle pixels, as shown in FIG. 4. The method first computes the average of the current pixel with all its adjacent pixels (step 410). The difference between the current pixel and the average is computed (step 420). If the difference is greater than a fourth base value, the pixel is marked as a speckle pixel (step 430). The curent embodiment sets the fourth base value as 7.

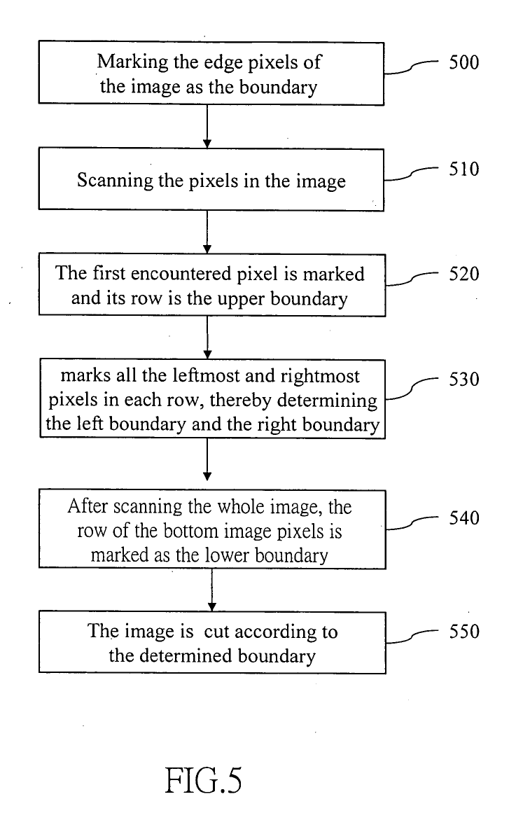

The steps of determining the image boundary can be implemented using various methods. As shown in FIG. 5, the image is first converted into the YcbCr format. The edge pixels of the image are marked as the boundary (step 500). The pixels in the image is scanned (step 510) to search for the actual image pixels. The first encountered pixel is marked and its row is the upper boundary (step 520). The method keeps scanning the image and compares the leftmost pixel of each row to the leftmost pixel of its previous row. If the latter is on the left side of the former, the boundary is updated. This method marks all the leftmost and rightmost pixels in each row, thereby determining the left boundary and the right boundary (step 530). After scanning the whole image, the row of the bottom image pixels is marked as the lower boundary (step 540). This completes the determination of the four boundaries. The image is then cut according to the determined boundary (step 550). The scanning process removes isolated speckle pixels in the image. The pixels thus found are the actual image pixels.

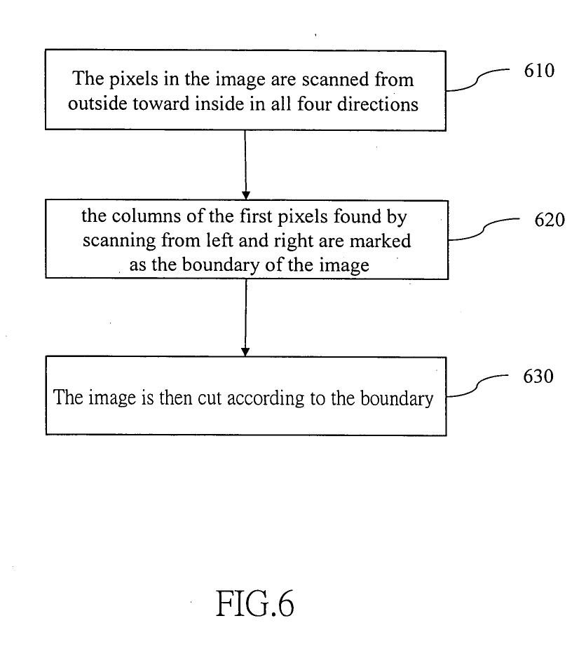

Please refer to FIG. 6 for the third embodiment of determining the image boundary according to the invention. First, the image is converted into the YcbCr format. The pixels in the image are scanned from outside toward inside in all four directions (step 610). The scanning from top and bottom is by rows, while the scanning from left and right is by columns. The background pixels and speckle pixels in the image are removed. The rows of the first pixels found by scanning from top and bottom are marked as the boundary of the image. Likewise, the columns of the first pixels found by scanning from left and right are also marked as the boundary of the image (step 620). The image is then cut according to the boundary (step 630). The current embodiment scans the image from the boundary toward the center until image points are found. Therefore, it does not need to scan all points in the image and saves a lot of time.

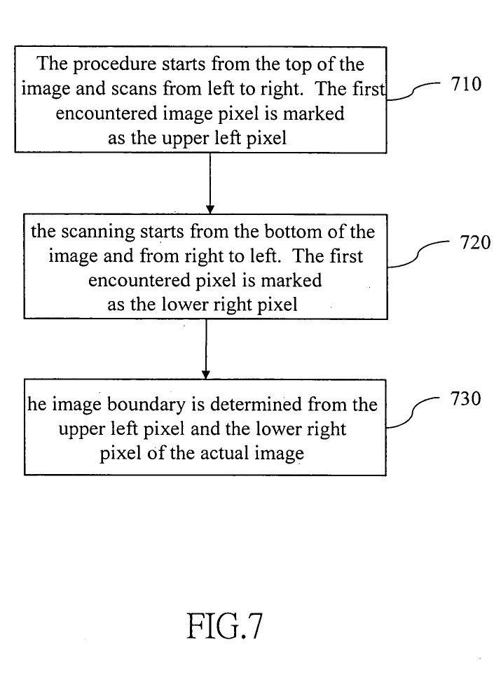

FIG. 7 shows the procedure of determining the image boundary according to a fourth embodiment of the invention. This embodiment uses the upper left pixel and the lower right pixel of the image to determine the image boundary. The procedure starts from the top of the image and scans from left to right. The first encountered image pixel is marked as the upper left pixel (step 710). Afterwards, the scanning starts from the bottom of the image and from right to left. The first encountered pixel is marked as the lower right pixel (step 720). After determining the upper left pixel and the lower right pixel of the actual image, the image boundary is determined from the two pixels (step 730). The image is then cut according to the boundary.

Certain variations would be apparent to those skilled in the art, which variations are considered within the spirit and scope of the claimed invention.

1. An automatic digital image cutting method for determining a boundary of an image and automatically cutting the image, the method comprising the steps of:
extracting the brightness values of pixels in the image;
determining quasi-image pixels according to the brightness values;
extracting image pixels from the quasi-image pixels;
determining the image boundary according to the image pixels; and
cutting the image according to the boundary.

2. The method of claim 1, wherein the step of determining quasi-image pixels according to the brightness values is performed by removing background pixels in the image according to the brightness values.

3. The method of claim 1, wherein the step of extracting image pixels from the quasi-image pixels is performed by removing speckle pixels from the quasi-image pixels.

4. The method of claim 1, wherein the step of determining the image boundary according to the image pixels includes the steps of:
extracting the edge pixels of the image; and
determining the image boundary according to the edge pixels.

5. The method of claim 1, wherein the step of determining the image boundary according to the image pixels includes:
marking the edge pixels of the image as the boundary;
scanning the image by rows, marking an encountered image pixel, and updating the row of the marked image pixel as the new boundary;
marking the current pixel and comparing it with the position of the current boundary; and
updating the column of the current image pixel outside the boundary as the new boundary.

6. The method of claim 5 further comprising the step of marking the first pixel as the upper boundary and the last pixel as the lower boundary.

7. The method of claim 1, wherein the step of determining the image boundary according to the image pixels includes the steps of:
scanning the image by rows and marking the row of the first image pixel as the upper boundary and the row of the last image pixel as the lower boundary; and
scanning the image by columns and marking the column of the first pixel as the left boundary and the column of the last pixel as the right boundary.

8. The method of claim 1, wherein the step of determing the image boundary according to the image pixels includes the steps of:
scanning the image by rows from the top and from left to right, marking the first encountered image pixel as an upper left pixel;
scanning the image by rows from the bottom and from right to left, marking the first encountered image pixel as a lower right pixel; and
determining the image boundary according to the upper left pixel and the lower right pixel.

9. The method of claim 3, wherein the step of determining the speckle pixels includes the steps of:
computing the difference between the current pixel and each of its adjacent pixels;
marking the adjacent pixel as a special pixel when the difference is greater than a second base value;
counting the number of the special pixels surrounding the current pixel;
marking the current pixel as a speckle pixel when the number of special pixels is greater than a third base value.

10. The method of claim 3, wherein the step of determining the speckle pixels includes the steps of:
computing the average value of the current pixel and all its adjacent pixels;
computing the difference between the current pixel and the average value; and
marking the current pixel as a speckle pixel when the difference is greater than a fourth base value.
